(19) United States
(12) Patent Application Publication
(10) Pub. No.: US 2018/0060950 A1
(43) Pub. Date: Mar. 1, 2018

(54) Process and system in which the user can rent an individual's private dwelling for a hourly time frame to include event or meeting space, outdoor event space, temporary pet housing, or parking

(71) Applicant: Jennifer Doyle, Morro Bay, CA (US)

(72) Inventor: Jennifer Doyle, Morro Bay, CA (US)

(21) Appl. No.: 15/255,097

(22) Filed: Sep. 1, 2016

(51) Int. Cl. G06Q 30/06; G06F 17/30; H04L 29/08; G06Q 10/02

(52) U.S. Cl. CPC G06Q 30/0645; G06F 17/30867; G06F 17/30241; G06Q 10/02; G06F 17/3087; H04L 67/306

(57) ABSTRACT

This current invention is a system and app is aimed to make it easy for people and cheap to rent and get properties on rent and provide and get day care services for pet on hourly basis along with other services. Service user can search for property and then apply for booking, Owner can also see the profile of the person who has requested to book the property and based on rating he can choose to confirm or reject the booking, the booking is confirmed by property owner.

### CROSS-REFERENCES TO RELATED APPLICATIONS (IF ANY)

None

### BACKGROUND

### 1. Field of the Invention

The present invention relates to a process to record and generate property rentals and in more particularly for hourly periods of time.

### 2. Description of Prior Art

Currently, there are no applications on the market that allow widespread rental of space for just a few hours. While there is a great need for the rental of such space for travelers, backpacks and people who have to relocate for short periods of time for their work.

There is still room for improvement in the art.

### SUMMARY OF THE INVENTION

The current invention is system and application in which the user can rent an individual's private dwelling for a short time frame such as hourly to include event or meeting space, outdoor event space, temporary pet housing, or parking. This patent will include each user feature separate from the other or combined.

The system, in the preferred embodiment, would work like a smartphone application, this product would be available through the respective marketplace for smartphones.

The process would be that a user would register and login. They would either list space/property or be searching for space or property. Next, the attributes that are desired are compared to the attributes for the house like size, number of guests, theme, length of time needed/available, pets and pricing.

Once a place is found there will be pictures of the place, a description of the place, amenities, house rules and availability.

The system will process the date, timeframe and request booking. Once booked the system will send out a confirmation message.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen;

FIG. 3 shows a sample of a profile screen;

FIG. 4 displays the payment setup screen;

FIG. 5 displays property being added to the system;

FIG. 6 displays pictures of the property being added to the system;

FIG. 7 shows a calendar for a property; and

FIG. 8 displays the properties rented

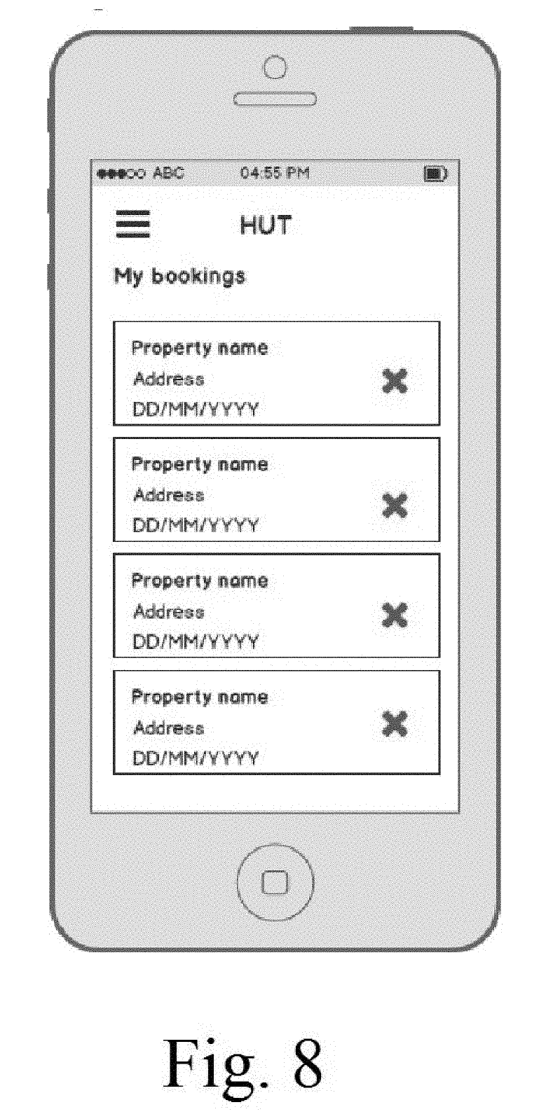

### DESCRIPTION OF THE PREFERRED EMBODIMENT

There are a number of significant design features and improvements incorporated within the invention.

The current invention is a system and application that would allow consumers to rent a house or location for a hourly period of time for things like special events.

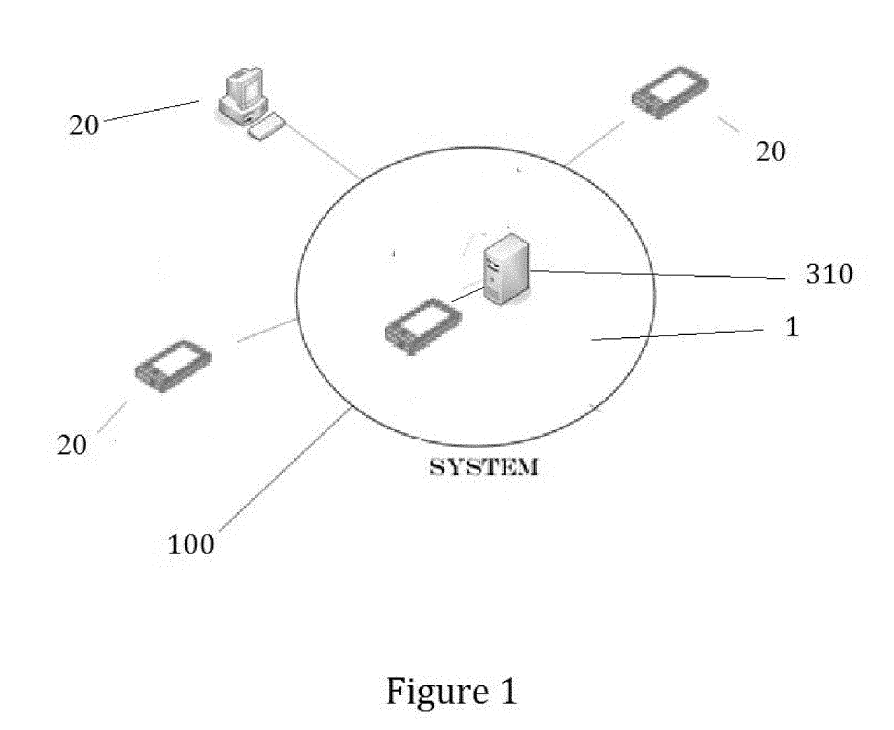

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 10 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

Brief Overview

This current invention is a system 1 and app is aimed to make it easy for people and cheap to rent and get properties on rent and provide and great day care services for pet on hourly basis. It is a system and computer application (app) in which the user can rent an individual's private dwelling for a hourly time frame to include event or meeting space, outdoor event space, temporary pet housing, or parking. The system 1 will include each user feature separate from the other or combined.

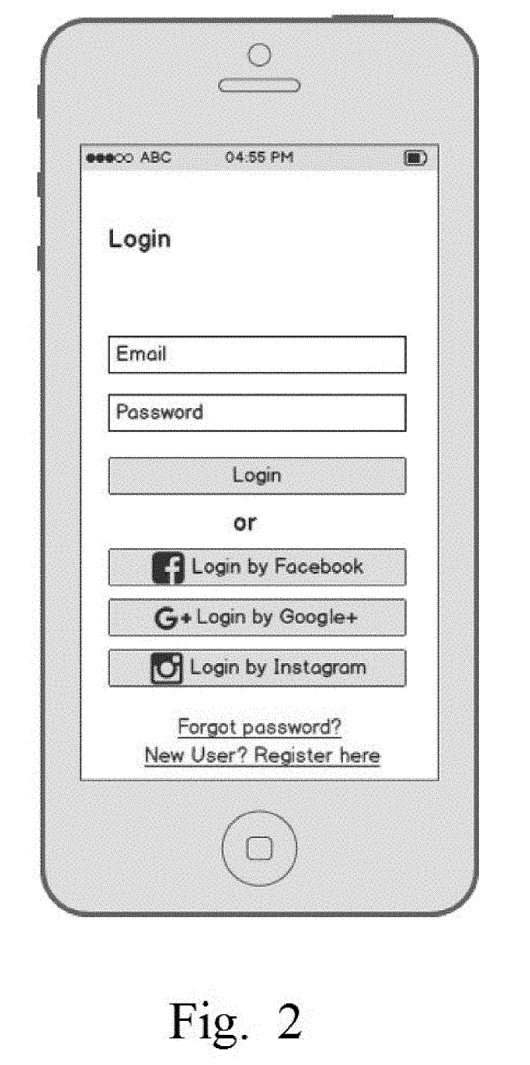

The users would sign-in directly or using social logins as shown in FIG. 2 with the user registering the app,

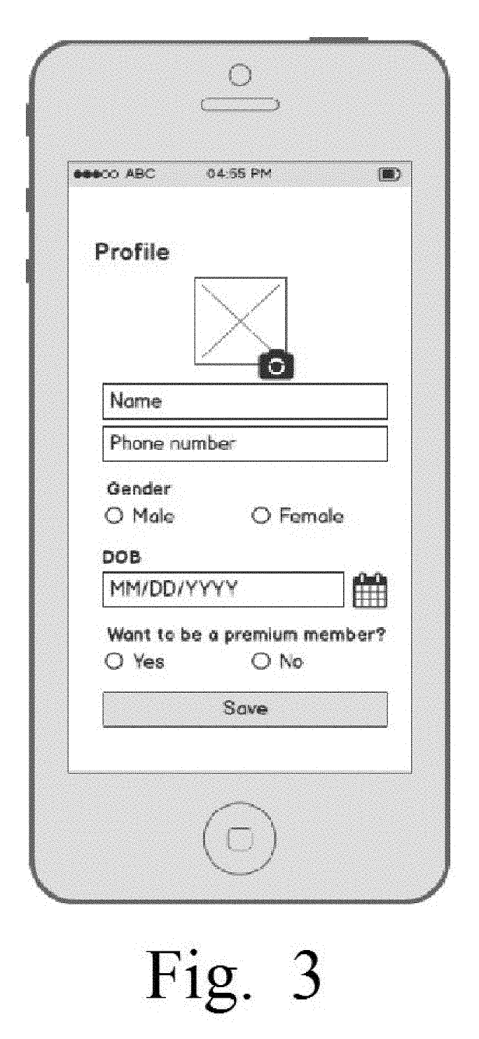

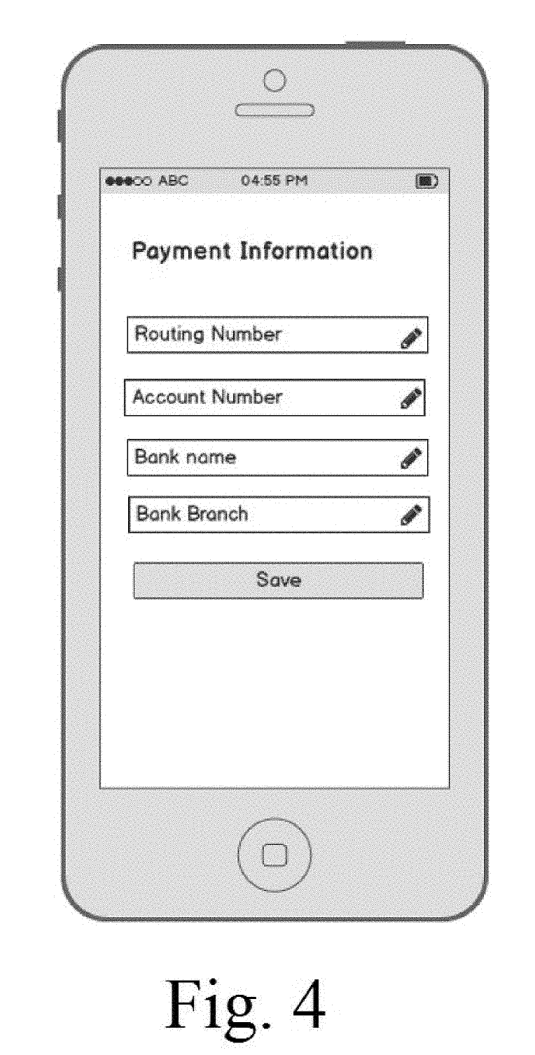

The user will set up their profile for the system using the profile screen as shown in FIG. 3 as well as the payment method as shown in FIG. 4. The payment screen will be set up account details to accept any normal method of payment.

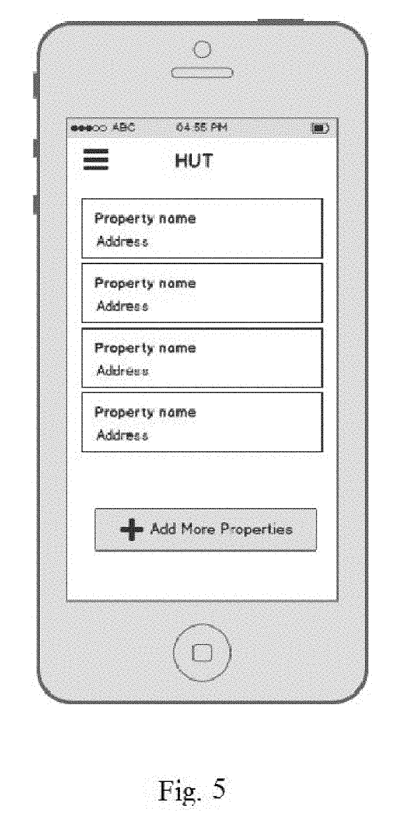

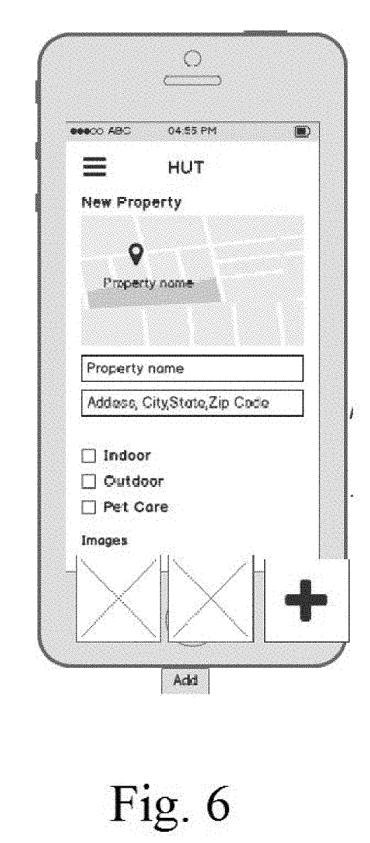

The user will Upload property details as shown in FIG. 5. It will list each property separately. FIG. 6 shows a screens shot of when the property is available.

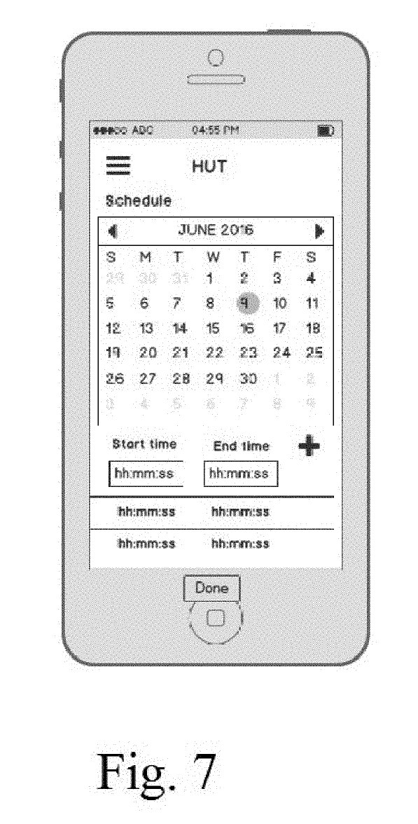

The system 1 can show the user the properties that they have rented as shown in FIG. 7.

The system 1 can list which rooms are available for an event. It can set time for which property will be available for renting. It can list price of the property for particular event for standard time which can be set by the system.

The system 1 can list property for shower and shave uses. This can be done in real time option. The system 1, for the use of a bathroom facility for the purpose of showering with real time ping option to locate available homes near the user. This is a unique feature and function that can be very useful to any type of traveler.

The property owners will receive percentage share of amount that renting user will pay. The owners can set their own rates per hour and basic amount for the minimum amount of tie. The owner can base their rates on the amount of people such as the basic pay for renting property is for 10 persons or less. Additional persons can be charged extra. The system 1 will allow the owner to rent out parking space as rented property for parking facility. The owner can also set the pet options for the property whether no pets or a surcharge for pets.

There is a status option for owner of property to display whether the property is still available for booking or not which works with the calendar screen.

The owner can also choose to day care for pets on time basis with a set hourly rate for day care for pets. They can also set the type of pets they can take care of. The system 1 will allow for upload images of pets at various time intervals for the real owner to cross check whether their pets are taken care of or not.

The system 1 will also handle cancellation. Advance booking cannot be canceled by service user before a set amount of time prior to the booking time such as one hour. It will deduct money if the booking is canceled by service user before 1 hour of booking time.

The system 1 will allow a service user can search property based on price, location and services provided for example parking and dog services collectively. The system 1 will receive the payment from the service user. It can be made in advance by service user and payment to owner will be made only after event completion

The system 1 is set up to send optional Pings. This can be issued on the sole discretion of the owner.

The system 1 will have a rating and feedback system for both owner and service user.

Each can each other at the end of event and give feedback. In the preferred embodiment, the feedback will be shown when any user searches for any service provider. The system 1 will have the rating and feedback category based. The system 1 could autoblock users who have less than or equal to 2 starts after 5 events is a option admin can choose to include in the system 1.

Operation

Service user can search for property and then apply for booking, Owner can also see the profile of the person who has requested to book the property and based on rating he can choose to confirm or reject the booking, the booking is confirmed by property owner.

The system 1 can provide each feature either separately or combined together. For example, the system 1 can be used for a shower and shave function at the same time it if functioning as pet boarding system.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
displaying a plurality of property up for rent for an hourly period of time by the owner; having a service search for property and then apply for booking, Owner can also see the profile of the person who has requested to book the property and based on rating he can choose to confirm or reject the booking, the booking is confirmed by property owner.

2. A system according to claim 1 having the property owner set the time period available.

3. A system according to claim 1 having the users set up profiles.

4. A system according to claim 1 having the rent be for one or more events or meeting space, outdoor event spaces, temporary pet housing, or parking.

5. A system according to claim 1 having a rating and feedback system for both owner and service user.

6. A system according to claim 5 having both owner and service user give feedback at the end of an event.

7. A system according to claim 5 having the feedback category based.

8. A system according to claim 5 having the feedback shown when any user searches for any service provider.

9. A system according to claim 5 autoblocking users who have less than a set feedback score.

10. A system according to claim 1 listing property for shower and shave uses.

11. A system according to claim 1 listing property for shower and shave uses in real time.

12. A system according to claim 11 pinging a user in real time ping on locations near the user.

13. A system according to claim 1 providing each feature either separately or combined.
